(19) United States
(12) Patent Application Publication
(10) Pub. No.: US 2014/0293583 A1
(43) Pub. Date: Oct. 2, 2014

(54) OPTICAL FILM FIXING STRUCTURE, BACKLIGHT MODULE, AND ASSEMBLY METHOD THEREOF

(71) Applicant: SHENZHEN CHINA STAR OPTOELECTRONICS TECHNOLOGY CO., LTD., Shenzhen, Guangdong (CN)

(72) Inventor: Chengling Lv, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/979,659

(22) PCT Filed: Jun. 26, 2013
(86) PCT No.: PCT/CN2013/078080

§ 371 Date: Jul. 15, 2013

(30) Foreign Application Priority Data
Mar. 26, 2013 (CN) 201310101117.4

(51) Int. Cl. F21V 17/18; G02F 1/1335

(52) U.S. Cl. CPC F21V 17/18; G02F 1/133608
USPC 362/97.2; 362/433

(57) ABSTRACT

The present disclosure provides an optical fixing structure, a backlight module, and an assembly method thereof. The optical film fixing structure includes a back plate, a receiving portion, a connecting member, and a rotating member; wherein the receiving portion is fixed onto the back plate, a lower end of the connecting member is connected to the receiving portion, an upper end of the connecting member is connected to the rotating member, a fixing force is generated and applied to an optical film located between the rotating member and the receiving member by rotating the rotating member along a predetermined direction. In the present disclosure, the connecting member is connected to the receiving portion, and the optical film suspends on the connecting member.

### BACKGROUND

1. Technical Field

The present disclosure relates to liquid crystal display technologies, and more particularly to an optical film fixing structure, a backlight module, and an assembly method thereof.

2. Description of Related Art

At present, liquid crystal displays are designed to be lighter and thinner, especially the liquid crystal displays applicable in portable devices such as notebook computers, personal digital assistances, and mobile phones, etc. Meanwhile, the reductions of material cost and assembly cost of the liquid crystal displays are also imperative. Based on the whole design of the system, the lighter and thinner designs of liquid crystal panels are often in conflict with the structure strengths of the liquid crystal panels.

A backlight module of an existing liquid crystal panel includes a rubber frame, a lower diffuser, a prism optical film, and an upper diffuser. A reflective plate and a backlight source are configured on a plastic frame, and a light guide plate is configured between the plastic frame and the lower diffuser. After being assembled to the rubber frame, the way that the optical films, including the lower diffuser, the prism optical film, and the upper diffuser are fixed to the rubber frame become very important. As shown in FIG. 1, at present, the optical film 11 is fixed by suspending and fixing the optical film via a rivet column 12 on a backlight plate 14 or a convex stage around the rivet column 12 and further by attaching the optical film via adhesive tape. The optical film 11 cannot be completely fixed by the rubber frame 13 and may fall off during transportation, assembly or testing processes like mechanical vibration testing processes and impact processes.

Therefore, it is urgent to find a fixing way of the optical film which can prevent the optical film from falling off during transportation, assembly or testing processes like mechanical vibration testing process and impact process.

### SUMMARY

The main object of the present disclosure is to provide an optical film fixing structure, a backlight module, and an assembly method thereof for realizing the fixing of the optical film in the backlight module.

The optical film fixing structure provided in the present disclosure includes a back plate, a receiving portion, a connecting member, and a rotating member; wherein the receiving portion is fixed onto the back plate, a lower end of the connecting member is connected to the receiving portion, an upper end of the connecting member is connected to the rotating member, a fixing force is generated and applied to an optical film located between the rotating member and the receiving member by rotating the rotating member along a predetermined direction.

Preferably, the receiving portion includes a latching hole, and the lower end of the connecting member is connected to the latching hole of the receiving portion.

Preferably, the latching hole is in interference fit with the connecting member or the connecting member is movably connected to the latching hole.

Preferably, the optical film defines a fixing hole, and a width of the fixing hole is less than a length of the rotating member.

Preferably, the connecting member is integrally formed with the rotating member or the rotating member is movably connected to the connecting member.

Preferably, the back plate is configured with a latching boss, the receiving portion is configured with a hook, and the hook of the receiving portion is fixed onto the latching boss of the back plate.

Preferably, the rotating member is racetrack shaped, oval shaped, or U shaped.

The present disclosure further provides an assembly method of the optical film fixing structure, includes: fixing the receiving portion onto the latching boss of the back plate; connecting the connecting member with the latching hole of the receiving portion such that the connecting member is in interference fit with the latching hole or is movably connected to the latching hole; movably connecting the upper end of the connecting member with the rotating member or integrally forming the upper end of the connecting member with the rotating member, and fixing the optical film between the rotting member and the receiving portion by rotating the rotating member along a predetermined direction.

The present disclosure further provides a liquid crystal backlight module including the above optical film fixing structure.

The present disclosure yet further provides an assembly method of a liquid crystal backlight module including the assembly method of the above liquid crystal backlight module.

In the present disclosure, the connecting member is connected to the receiving portion, and the optical film suspends on the connecting member. The fixing force is generated and applied to the optical film between the rotating member and the receiving portion by rotating the rotating member along the predetermined direction, thereby fixing the optical film between the rotating member and the receiving portion. With the rotation of the rotating member along the predetermined direction, the optical film can be assembled and disassembled quickly to reduce the required time and the production cost.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a structural view of a fixing structure of a present optical film;

FIG. 2A is a structural view of an optical film fixing structure, a backlight module, and an assembly method in accordance with a first embodiment of the present disclosure;

FIG. 2B is a schematic view showing the using state of the optical film fixing structure, the backlight module, and the assembly method in accordance with the first embodiment of the present disclosure;

FIG. 3 is a cross sectional view of FIG. 2 taken along the line A-A;

FIG. 4 is a cross sectional view of the structural view of the optical film fixing structure, backlight module, and assembly method thereof in accordance with a second embodiment of the present disclosure, taken along the line A-A; and

FIG. 5 is a cross sectional view of the structural view of the optical film fixing structure, backlight module, and assembly method thereof in accordance with a third embodiment of the present disclosure, taken along the line A-A.

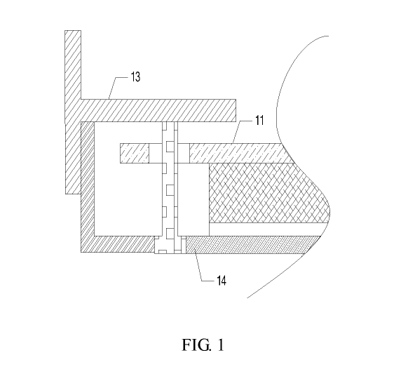

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

The present disclosure provides a fixing structure applied to an optical film in a backlight module, for fixing the optical film in the backlight module.

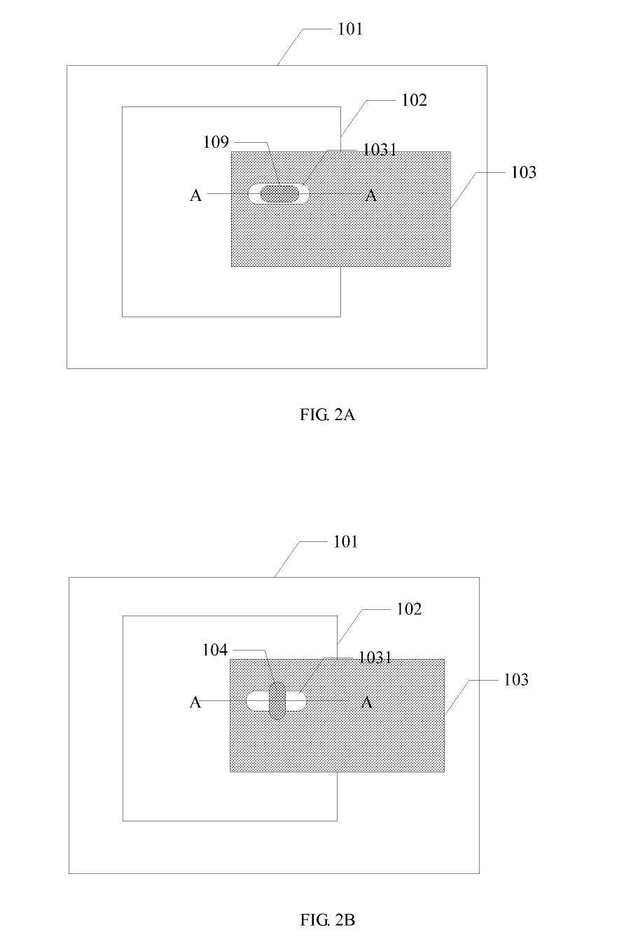

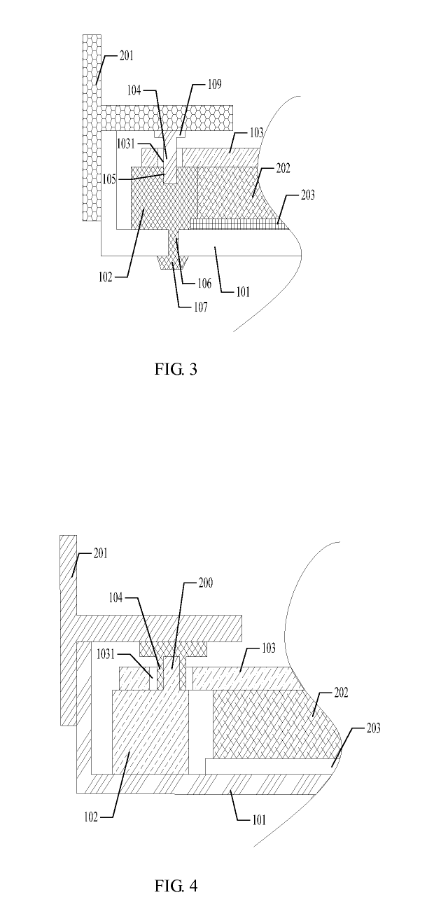

Referring to FIGS. 2A, 2B, and 3, in which FIG. 2A is a structural view of an optical film fixing structure, a backlight module, and an assembly method in accordance with a first embodiment of the present disclosure; FIG. 2B is a schematic view showing the using state of the optical film fixing structure, the backlight module, and the assembly method in accordance with the first embodiment of the present disclosure; and FIG. 3 is a cross sectional view of FIG. 2 taken along the line A-A. As shown in FIG. 2A, the optical film fixing structure provided in the present disclosure includes a back plate 101, a receiving portion 102, a connecting member 104, and a rotating member 109. The receiving portion 102 is fixed onto the back plate 101, a lower end of the connecting member 104 is connected to the receiving portion 102, and an upper end of the connecting member 104 is connected to the rotating member 109. As shown in FIG. 2B, a fixing force is generated and applied to the optical film 103 located between the rotating member 109 and the receiving portion 102 by rotating the rotating member 109 along a predetermined direction, thereby fixing the optical film 103 between the rotating member 109 and the receiving portion 102.

Specifically, as shown in FIG. 3, a hook 106 is configured under the receiving portion 102, a latching boss 107 engageable with the hook 106 is configured on the back plate 101, and the hook 106 of the receiving portion 102 is fixed onto the latching boss 107 of the back plate 101. It is noted that in other embodiments of the present disclosure, the receiving portion 102 can be fixed to the back plate 101 in other ways. For example, the receiving portion 102 can be attached to the back plate 101, which is not limited further here. The assembly and disassembly of the receiving portion 102 is facilitated by fixing the receiving portion 102 onto the back plate 101 using the method disclosed in the present embodiment, which can reduce the staff number and reduce consumed time. The receiving portion 102 is made of silicon, while in other embodiments the receiving portion 102 can be made of rubber or PC with certain forming capability and strength.

Furthermore, the receiving portion 102 includes a latching hole 105. The connecting member 104 is connected to the latching hole 105, and the lower end of the connecting member 102 is movably connected to the latching hole 105. The rotating member 109 is integrally formed with the connecting member 104. As shown in FIG. 2B, a fixing force is generated and applied to the optical film 103 located between the rotating member 109 and the receiving portion 102 by rotating the rotating member 109 along a predetermined direction, thereby fixing the optical film 103 between the rotating member 109 and the receiving portion 102. The connecting member 104 is movably connected to the latching hole 105 of the receiving portion 102. In other embodiments, the connecting member 104 can be connected to the latching hole in any suitable way, for example, the connecting member 104 can engage with the latching hole 105 with interference fit. The rotating member 109 and the connecting member 104 are integrally formed, while in other embodiments, the rotating member 109 can be movably connected to the connecting member 104 via screws or buckles. In the embodiment the rotating member 109 is oval shaped, while in other embodiments, the rotating member 109 can also be U-shaped or racetrack shaped. In the embodiment the connecting member 104 is cylinder shaped, while in other embodiments, the connecting member 104 can also be cuboid shaped, which is not separately further limited here. The optical film 103 further includes a fixing hole 1031. A space is defined between the rotating member 109 and the optical film 103. As shown in FIG. 2A, when a lengthwise direction of the rotating member 109 is the same as that of the fixing hole 1031, the optical film 103 can suspend on the connecting member 104. As shown in FIG. 2B, a fixing force is generated and applied to the optical film 103 located between the rotating member 109 and the receiving portion 102 by rotating the rotating member 109 along a predetermined direction, thereby fixing the optical film 103 between the rotating member 109 and the receiving portion 102. In the embodiment, the optical film 103 is fixed through the rotation of the rotating member 109. The space defined between the optical film 103 and the rotating member 109 not only provides an expansion space for the optical film 103, but also prevents the optical film 103 from falling off during reliability tests such as vibration tests and impact tests, or during transportation and moving processes.

Specifically, a width of the fixing hole 1031 is less than a length of the rotating member 109. As shown in FIG. 2A, when the longwise direction of the rotating member 109 is the same as that of the fixing hole 1031, the optical film 103 is placed into the fixing hole 1031. As shown in FIG. 2B, by rotating the rotating member 109 along a predetermined direction, the fixing force is generated and applied to the optical film 103 between the rotating member 109 and the receiving portion 102, thereby fixing the optical film 103 between the rotating member 109 and the receiving portion 102. In disassembly, as shown in FIG. 2A, the optical film 1031 can be disassembled easily by rotating the rotating member 109 to make the lengthwise direction of the rotating member 109 be the same as that of the fixing hole 1031. The connecting member 104 and the rotating member 109 can be integrally formed to be a rotating element, or, the connecting member 104 and the rotating member 109 also can be independent elements which are movably connected together. With the movable connection of the connecting member 104 and the receiving portion 102, the fixing force is generated and applied to the optical film 103 located between the rotating member 109 and the receiving portion 102 by rotating the rotating member 109 along the predetermined direction, thereby fixing the optical film 103 between the rotating member 109 and the receiving portion 102.

In the present disclosure, the connecting member is connected to the receiving portion, and the optical film suspends on the connecting member. The fixing force is generated and applied to the optical film between the rotating member and the receiving portion by rotating the rotating member along the predetermined direction, thereby fixing the optical film between the rotating member and the receiving portion. With the rotation of the rotating member along the predetermined direction, the optical film can be assembled and disassembled quickly to reduce the required time and the production cost.

The present disclosure further provides an assembly method of the optical film fixing structure, includes: fixing the hook 106 of the receiving portion 102 onto the latching boss 107 of the back plate 101, connecting the connecting member 104 and the receiving portion 102, movably connecting the connecting member 104 and the latching hole 105; suspending the optical film 103 on the connecting member 104 when the lengthwise direction of the rotating member 109 is the same as that of the fixing hole 1031 of the optical film 103, as shown in FIG. 2A; rotating the rotating member 109 along the predetermined direction such that the fixing force can be applied to the optical film located between the rotating member 109 and the receiving portion 102, thereby fixing the optical film 103 between the receiving portion 102 and the rotating member 109, as shown in FIG. 2B. In the embodiment, when disassembling the optical film, the rotating member 109 is rotated to make the lengthwise direction of the rotating member 109 be the same as that of the fixing hole 1031; when fixing the optical film 103, the rotating member 109 is rotated along the predetermined direction. This facilitates the assembly, fixing, and disassembly of the optical film 103, reduces the required work amount and working time, optimizes the assembly process, and reduces the production cost.

The present disclosure further provides a backlight module. As shown in FIG. 3, the backlight module includes an optical film fixing structure, and further includes a rubber frame 201, a light guide plate 202, and a reflective plate 203. The optical film fixing structure can be referred to what is mentioned above, no more tautology here. By applying the optical film fixing structure in the back light module, the assembly, fixing, and disassembly of the optical film can be facilitated, the required working amount and working time can be reduced, the assembly process can be optimized, and the production cost can be reduced. Meanwhile, the optical film fixing structure not only allows for the fixing the optical film, but also defines a space providing an expansion space for the optical film, which prevents the shape and quality of the optical film from being affected due to the lack of expansion space, and thus improves the quality of the optical film.

The present disclosure further provides an assembly method of the backlight module. The assembly method of the backlight module includes the assembly method of the optical film fixing structure, which can be referred to what is mentioned above, no more tautology here. By applying the above optical film fixing structure in the backlight module, the assembly, fixing, and disassembly of the optical film can be facilitated, the required working amount and working time can be reduced, the assembly process can be optimized, and the production cost can be reduced. Meanwhile, the optical film fixing structure not only allows for the fixing the optical film, but also defines a space providing an expansion space for the optical film, which prevents the shape and quality of the optical film from being affected due to the lack of expansion space, and thus improves the quality of the optical film.

In the present disclosure, the connecting member is connected to the receiving portion, and the optical film suspends on the connecting member. The fixing force is generated and applied to the optical film between the rotating member and the receiving portion by rotating the rotating member along the predetermined direction, thereby fixing the optical film between the rotating member and the receiving portion. With the rotation of the rotating member along the predetermined direction, the optical film can be assembled and disassembled quickly to reduce the required time and the production cost.

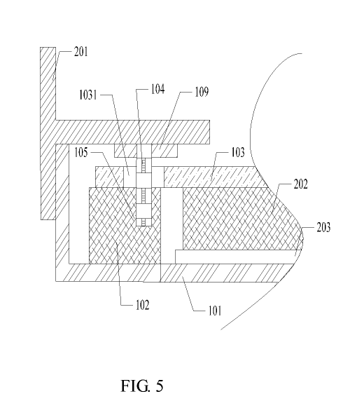

As shown in FIG. 4, which is a cross sectional view of the structural view of the optical film fixing structure, backlight module, and assembly method thereof in accordance with a second embodiment of the present disclosure, taken along the line A-A.

The difference between the second embodiment and the first embodiment lies in: the receiving portion 102 is attached to the back plate 101, the connecting member 104 is integrally formed with the rotating member 109 to be an integral rotating element, the receiving portion 102 is formed with a convex boss 200, and the rotating element formed by the connecting member 104 and the rotating member 109 is movably connected to the convex boss 200. The optical film 103 is fixed between the rotating member 109 and the receiving portion 102 by rotating the rotating element formed by the connecting member 104 and the rotating member 109.

As shown in FIG. 5, which is a cross sectional view of the structural view of the optical film fixing structure, backlight module, and assembly method thereof in accordance with a third embodiment of the present disclosure, taken along the line A-A.

The difference between the third embodiment and the first embodiment lies in: the receiving portion 102 is attached to the back plate 101, the connecting member 104 is movably connected to the rotating member 109, and the latching hole 105 of the receiving portion 102 is in interference fit with the connecting member 104. By rotating the rotating member 109, the optical film 103 is fixed between the rotating member 109 and the receiving portion 102.

In the present disclosure, the connecting member is connected to the receiving portion, and the optical film suspends on the connecting member. The fixing force is generated and applied to the optical film between the rotating member and the receiving portion by rotating the rotating member along the predetermined direction, thereby fixing the optical film between the rotating member and the receiving portion. With the rotation of the rotating member along the predetermined direction, the optical film can be assembled and disassembled quickly to reduce the required time and the production cost.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. An optical film fixing structure, comprising a back plate, a receiving portion, a connecting member, and a rotating member; wherein the receiving portion is fixed onto the back plate, a lower end of the connecting member is connected to the receiving portion, an upper end of the connecting member is connected to the rotating member, a fixing force is generated and applied to an optical film located between the rotating member and the receiving member by rotating the rotating member along a predetermined direction.

2. The optical film fixing structure of claim 1, wherein the receiving portion comprises a latching hole, and the lower end of the connecting member is connected to the latching hole of the receiving portion.

3. The optical film fixing structure of claim 2, wherein the latching hole is in interference fit with the connecting member or the connecting member is movably connected to the latching hole.

4. The optical film fixing structure of claim 1, wherein the optical film defines a fixing hole, and a width of the fixing hole is less than a length of the rotating member.

5. The optical film fixing structure of claim 1, wherein the connecting member is integrally formed with the rotating member or the rotating member is movably connected to the connecting member.

6. The optical film fixing structure of claim 1, wherein the back plate is configured with a latching boss, the receiving portion is configured with a hook, and the hook of the receiving portion is fixed onto the latching boss of the back plate.

7. The optical film fixing structure of claim 2, wherein the rotating member is racetrack shaped, oval shaped, or U shaped.

8. An assembly method of the optical film fixing structure of claim 2, comprising: fixing the receiving portion onto the latching boss of the back plate; connecting the connecting member with the latching hole of the receiving portion such that the connecting member is in interference fit with the latching hole or is movably connected to the latching hole; movably connecting the upper end of the connecting member with the rotating member or integrally forming the upper end of the connecting member with the rotating member, and fixing the optical film between the rotting member and the receiving portion by rotating the rotating member along a predetermined direction.

9. The assembly method of the optical film fixing structure of claim 8, wherein the connecting member is in interference fit with the latching hole or is movably connected to the latching hole.

10. The assembly method of the optical film fixing structure of claim 8, wherein the optical film defines a fixing hole, a width of the fixing hole of the optical film is less than a length of the rotating member.

11. The assembly method of the optical film fixing structure of claim 8, wherein the connecting member is integrally formed with the rotating member or the rotating member is movably connected to the connecting member.

12. The assembly method of the optical film fixing structure of claim 8, wherein the back plate is configured with a latching boss, the receiving portion is configured with a hook, and the hook of the receiving portion is fixed onto the latching boss of the back plate.

13. The assembly method of the optical film fixing structure of claim 8, wherein the rotating member is racetrack shaped, oval shaped or U shaped.

14. A liquid crystal backlight module, wherein the liquid crystal backlight module comprises the optical film fixing structure of claim 1.

15. The liquid crystal backlight module of claim 14, wherein the receiving portion comprises a latching hole, and the lower end of the connecting member is connected to the latching hole of the receiving portion.

16. The liquid crystal backlight module of claim 15, wherein the connecting member is in interference fit with the latching hole or is movably connected to the latching hole.

17. The liquid crystal backlight module of claim 14, wherein the optical film defines a fixing hole, and a width of the fixing hole of the optical film is less than a length of the rotating member.

18. The liquid crystal backlight module of claim 14, wherein the connecting member is integrally formed with the rotating member or the rotating member is movably connected to the connecting member.

19. The liquid crystal backlight module of claim 14, wherein the back plate is configured with a latching boss, the receiving portion is configured with a hook, and the hook of the receiving portion is fixed onto the latching boss of the back plate.

20. The liquid crystal backlight module of claim 15, the rotating member is racetrack shaped, oval shaped or U shaped.
